(19) United States
(12) Patent Application Publication
(10) Pub. No.: US 2023/0183476 A1
(43) Pub. Date: Jun. 15, 2023

(54) Acid Resistant Polyoxymethylene Composition and Articles Made Therewith

(71) Applicant: Celanese International Corporation, Irving, TX (US)

(72) Inventors: Sung Hye Kim, Erlanger, KY (US); Lowell Jay Larson, Independence, KY (US); Roger Wright, Union, KY (US)

(21) Appl. No.: 18/078,501

(22) Filed: Dec. 9, 2022

Related U.S. Application Data
(60) Provisional application No. 63/288,320, filed on Dec. 10, 2021.

(51) Int. Cl. C08L 71/02

(52) U.S. Cl. CPC C08L 71/02

(57) ABSTRACT

Polyoxymethylene polymer compositions and molded articles made from the composition are disclosed that are fuel resistant, particularly diesel fuel resistant, and resistant to highly acidic solutions. The polymer composition contains a polyoxymethylene polymer combined with a combination of stabilizers, such as a combination of at least three different stabilizers. In addition, the polymer composition contains an acid neutralizing agent and optionally a plasticizer.

### RELATED APPLICATIONS

The present application is based upon and claims priority to U.S. Provisional Pat. Application Serial No. 63/288,320, having a filing date of Dec. 10, 2021, which is incorporated herein by reference.

### BACKGROUND

Polyacetal polymers, which are commonly referred to as polyoxymethylene polymers, have become established as exceptionally useful engineering materials in a variety of applications. Polyoxymethylene polymers, for instance, are widely used in constructing molded parts, such as parts for use in the automotive industry and the electrical industry. Polyoxymethylene polymers, for instance, have excellent mechanical property, fatigue resistance, abrasion resistance, chemical resistance, and moldability.

Because of their excellent mechanical properties, heat resistance and chemical resistance, polyoxymethylene polymers have been used in the past to produce components for various vehicles, such as cars and trucks. For example, because polyoxymethylene polymers do not significantly degrade when contacted with fuels, molded parts made from polyoxymethylene polymers have been used to produce fuel lines and other vehicle parts where the part is repeatedly contacted with vehicle fuels. In addition to being fuel resistant, the polyoxymethylene polymer compositions also have good impact resistance properties which makes molded parts made from the polymers resistant to damage or crack formation during normal wear and tear.

Particular problems, however, are faced when polyoxymethylene compositions are designed to contact diesel fuel. Diesel fuel, for instance, can contain sulfur or sulfur-containing compounds. When the diesel fuel is heated for prolong periods of time, the sulfur-containing compounds can oxidize and produce acidic sulfur compounds, which can decompose many different synthetic polymers, including having some effect on polyoxymethylene polymers. Thus, in the past, polyoxymethylene polymers have been combined with various different additives such as a hindered amine light stabilizer or a zinc oxide in order to make the polymer more resistant to contact with corrosive agents that may form from diesel fuel.

Recently, more and more cars and trucks are being made with decorative rims for the tires of the vehicle. In many instances, the decorative rims are made from a polished metal, chrome, or the like. In order to clean these materials, consumers and commercial car and truck washing establishments typically use a wheel cleaner that is highly acidic. For example, a wheel cleaner can have a pH below 3, and even below 2. These wheel cleaners are commonly sprayed onto fuel components of the car during application to the wheel. These highly acidic solutions can cause rapid aging of the fuel components, causing the components to degrade and fail over time.

In view of the above, those skilled in the art have attempted to formulate polyoxymethylene polymer compositions that are resistant to acids. For example, U.S. Pat. No. 7,247,665 and U.S. Pat. Publication No. 2018/0319980, which are both incorporated herein by reference, disclose polyoxymethylene polymer compositions with improved acid resistance. Although both of the above patent publications disclose compositions that have displayed significant improvements in the art, further improvements in acid resistance are still needed.

In particular, a need exists for a polyoxymethylene polymer composition that has improved acid resistance. In particular, a need exists for a polyoxymethylene polymer composition containing additives that can enhance the ability of acid scavengers in order to further improve acid resistance and possibly other properties.

### SUMMARY

In general, the present disclosure is directed to a polymer composition containing primarily a polyoxymethylene polymer and to molded products made from the composition. The polymer composition of the present disclosure is particularly formulated to be acid resistant. More particularly, the polymer composition of the present disclosure and articles molded from the composition are well suited for contact with various fuels including diesel fuels and for contact with highly acidic liquids, such as various cleaning agents. After repeated contact with fuels and acidic solutions, articles molded in accordance with the present disclosure resist significant degradation.

The polymer composition of the present disclosure generally contains a polyoxymethylene polymer and one or more acid neutralizing agents. In addition, the polymer composition contains an additive package comprising a combination of stabilizers that can synergistically combine with the other ingredients to improve acid resistance and/or fuel resistance. The stabilizer package can also improve other properties including mold release properties and the like.

In one embodiment, for instance, the polymer composition comprises a polyoxymethylene polymer in combination with at least one acid neutralizing agent and optionally a plasticizer. In accordance with the present disclosure, the polymer composition further contains a combination of stabilizers. The combination of stabilizers includes a hindered phenolic antioxidant, an aromatic amine stabilizer, and a thioester stabilizer. In one aspect, the hindered phenolic antioxidant can be present in the composition in an amount greater than the aromatic amine stabilizer and/or in an amount greater than the thioester stabilizer. For example, the weight ratio between the hindered phenolic antioxidant and the aromatic amine stabilizer can be from about 10:1 to about 1:1, such as from about 5:1 to about 1:1, such as from about 3:1 to about 1.5:1. The weight ratio between the hindered phenolic antioxidant and the thioester stabilizer can be from about 15:1 to about 1:1, such as from about 8:1 to about 1.5:1, such as from about 5:1 to about 2:1. In one aspect, the phenolic antioxidant is present in an amount from about 0.2% by weight to about 3.5% by weight. In one particular embodiment, the hindered phenolic antioxidant is present in the composition in an amount less than about 1.5% by weight, such as in an amount less than about 1% by weight, such as in an amount less than about 0.8% by weight, and generally in an amount greater than about 0.2% by weight.

In one aspect, the hindered phenolic antioxidant comprises tetrakis[methylene-3-(3,5-di-tert-butyl-4-hydroxyphenyl-propionate)]. The aromatic amine stabilizer can comprise 4-(1-methyl-1-phenylethyl)N-[4-(1-methyl-1-phenylethyl)phenyl]aniline. The aromatic amine stabilizer, in one aspect, can be present in the polymer composition in an amount from about 0.05% by weight to about 1.5% by weight. The thioester stabilizer can comprise distearyl thiodipropionate. The thioester stabilizer can be present in the composition in an amount of from about 0.03% by weight to about 1.3% by weight.

The polyoxymethylene polymer may comprise a polyoxymethylene copolymer and may be present in the polymer composition in an amount greater than about 70% by weight, such as in an amount greater than about 80% by weight, such as in an amount greater than about 90% by weight. In one embodiment, the polyoxymethylene polymer is present in the polymer composition in an amount less than about 96% by weight, such as in an amount less than about 95% by weight. The polyoxymethylene polymer can have a melt flow index of greater than about 0.5 g/10 min, such as greater than about 5 g/10 min, such as greater than about 9 g/10 min, such as greater than about 10 g/10 min, such as greater than about 11 g/10 min when measured according to ISO Test 1133 at 190° C. and at a load of 2.16 kg. The melt flow index is generally less than about 40 g/10 min, such as less than about 35 g/10 min, such as less than about 30 g/10 min. In one embodiment, the melt flow index is from about 10 g/10 min to about 15 g/10 min. Alternatively, the polyoxymethylene polymer can have a relatively low melt flow index of less than about 5 g/10 min, such as less than about 4 g/10 min, such as less than about 3 g/10 min, and generally greater than about 0.1 g/10 min.

As described above, the polyoxymethylene polymer is combined with at least one acid neutralizing agent and optionally a plasticizer. The acid neutralizing agent, in one aspect, comprises one or more magnesium compounds. In certain embodiments, for instance, the use of magnesium compounds can provide optimum acid resistance due to the physical properties of the particles. The magnesium compound, for instance, can be a hydroxide, an oxide, a carbonate, or the like.

In one embodiment, one or more acid neutralizing agents are present in the composition in an amount greater than about 2.5% by weight, such as in an amount greater than about 3.5% by weight, such as in an amount greater than about 4.5% by weight, such as in an amount greater than about 5.5% by weight, and generally in an amount less than about 15% by weight, such as in an amount less than about 10% by weight. In one aspect, the acid neutralizing agent comprises magnesium oxide only. Alternatively, the acid neutralizing agent may comprise magnesium hydroxide alone or in combination with magnesium oxide. In still another embodiment, the composition contains zinc oxide in combination with magnesium oxide and/or magnesium hydroxide.

As described above, the polymer composition further optionally contains a plasticizer. The plasticizer, for instance, may comprise a polyalkylene glycol. The polyalkylene glycol, for instance, can have a mean molecular weight of greater than about 2,000 g/mol, such as from about 3,000 g/mol to about 9,000 g/mol. The plasticizer can generally be present in the polymer composition in an amount greater than about 1% by weight, such as in an amount greater than about 1.3% by weight, such as in an amount greater than about 1.7% by weight, and generally in an amount less than about 10% by weight, such as in an amount less than about 5% by weight, such as in an amount less than about 4% by weight, such as in an amount less than about 3.3% by weight, such as in an amount less than about 2.8% by weight.

In other embodiments, the plasticizer may comprise an aromatic ester including aromatic polyesters, an aliphatic diester, an epoxide, a sulfonamide, a polyether, a polybutene, a polyamide, an acetylated monoglyceride, an alkyl citrate, or an organophosphate.

The polymer composition can also contain a wax. The wax, for instance, can be an ethylene bis(stearamide). The wax can be present in the polymer composition in an amount greater than about 0.05% by weight, such as in an amount greater than about 0.1 % by weight, such as in an amount greater than about 0.15% by weight, such as in an amount greater than about 0.18% by weight, and generally in an amount less than about 2% by weight, such as in an amount less than about 1% by weight, such as in an amount less than about 0.8% by weight, such as in an amount less than about 0.7% by weight.

The polymer composition can also contain a salt of a carboxylic acid, such as a salt of a hydroxycarboxylic acid. In one aspect, the polymer composition contains calcium hydroxystearate. The carboxylic acid compound, for instance, can be present in the polymer composition in an amount greater than about 0.1% by weight, such as in an amount greater than about 0.2% by weight, and generally in an amount less than about 1.5% by weight, such as in an amount less than about 1 % by weight, such as in an amount less than about 0.5% by weight.

As described above, the polymer composition is well suited for producing molded articles that are to contact fuel, such as diesel fuel. The polymer composition is also resistant to highly acidic solutions. In one embodiment, for instance, the polymer composition may be used to produce an exterior vehicle part. The molded article, for instance, may comprise a portion of the fuel system of a car or truck. In one embodiment, for example, the molded article may comprise a fuel contacting member. The fuel contacting member may comprise a fuel line, a fuel valve, or a fuel flange.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a side view of one embodiment of a fuel line made in accordance with the present disclosure;

FIG. 2 is a perspective view of one embodiment of a fuel flange made in accordance with the present disclosure; and

FIG. 3 is a graphical representation of the results obtained in the example below.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a polyoxymethylene polymer composition and to polymer articles made from the composition. The polymer composition contains a polyoxymethylene polymer and has acid and fuel resistant properties. In particular, the polymer composition of the present disclosure is resistant to highly acidic solutions or acidic byproducts that may come in contact with the fuel system of a vehicle, such as a car or truck. The highly acidic solution, for instance, may comprise a wheel cleaner, a rim cleaner, a chrome cleaner or the like. In the past, polyoxymethylene polymer compositions have been formulated so as to be diesel fuel resistant. Such formulations, however, may be susceptible to damage or degradation when contacted with a wheel or rim cleaner solution that is inadvertently contacted with parts or articles that make up the fuel system. In this regard, the present disclosure is directed to a polyoxymethylene polymer composition containing at least one acid neutralizing agent and a combination of stabilizers. The stabilizers are present in the composition in amounts and at ratios that have been found to dramatically improve acid resistance.

The composition of stabilizers contained in the polymer composition of the present disclosure, in one embodiment, includes a hindered phenolic antioxidant, an aromatic amine stabilizer, and a thioester stabilizer. Suitable hindered phenolic antioxidants that may be incorporated into the composition include those having one of the following general structures (IV), (V) and (VI):

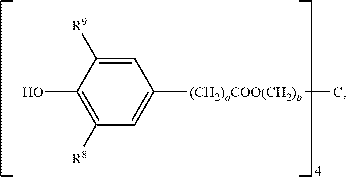

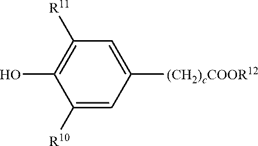

and

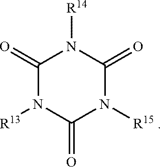

wherein,
a, b and c independently range from 1 to 10, and in some embodiments, from 2 to 6;
R⁸, R⁹, R¹⁰, R¹¹, and R¹² are independently selected from hydrogen, C₁ to C₁₀ alkyl, and C₃ to C₃₀ branched alkyl, such as methyl, ethyl, propyl, isopropyl, butyl, or tertiary butyl moieties; and
R¹³, R¹⁴ and R¹⁵ are independently selected from moieties represented by one of the following general structures (VII) and (VIII):

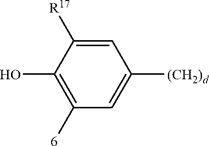

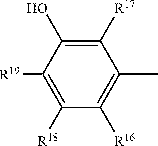

wherein,
d ranges from 1 to 10, and in some embodiments, from 2 to 6;
R¹⁶, R¹⁷, R¹⁸, and R¹⁹ are independently selected from hydrogen, C₁ to C₁₀ alkyl, and C₃ to C₃₀ branched alkyl, such as methyl, ethyl, propyl, isopropyl, butyl, or tertiary butyl moieties.

Specific examples of suitable hindered phenols having a general structure as set forth above may include, for instance, 2,6-di-tert-butyl-4-methylphenol; 2,4-di-tert-butyl-phenol; pentaerythrityl tetrakis(3,5-di-tert-butyl-4-hydroxyphenyl)propionate; octadecyl-3-(3′,5′-di-tert-butyl-4′-hydroxyphenyl)propionate; tetrakis[methylene(3,5-di-tert-butyl-4-hydroxycinnamate)]methane; bis-2,2′-methylene-bis(6-tert-butyl-4-methylphenol)terephthalate; 1,3,5-trimethyl-2,4,6-tris(3,5-di-tert-butyl-4-hydroxybenzyl)benzene; tris(3,5-di-tert-butyl-4-hydroxybenzyl)isocyanurate; 1,3,5-tris(4-tert-butyl-3-hydroxy-2,6-dimethylbenzyl)1 ,3,5-triazine-2,4,6- -(1 H,3H,5H)-trione; 1,1,3-tris(2-methyl-4-hydroxy-5-tert-butylphenyl)butane; 1,3,5-triazine-2,4,6(1 H,3H,5H)-trione; 1,3,5-tris[[3,5-bis-(1,1 -dimethylethyl)-4-hydroxyphenyl]methyl]; 4,4′,4″-[(2,4,6-trimethyl-1,3,5-benzenetriyl)tris-(methylene)]tris[2,6-b- is(1,1-dimethylethyl)]; 6-tert-butyl-3-methylphenyl; 2,6-di-tert-butyl-p-cresol; 2,2′-methylenebis(4-ethyl-6-tert-butylphenol); 4,4′-butylidenebis(6-tert-butyl-m-cresol); 4,4′-thiobis(6-tert-butyl-m-cresol); 4,4′-dihydroxydiphenyl-cyclohexane; alkylated bisphenol; styrenated phenol; 2,6-di-tert-butyl-4-methylphenol; n-octadecyl-3-(3′,5′-di-tert-butyl-4′-hydroxyphenyl)propionate; 2,2′-methylenebis(4-methyl-6-tert-butylphenol); 4,4′-thiobis(3-methyl-6-tert-butylphenyl); 4,4′-butylidenebis(3-methyl-6-tert-butylphenol); stearyl-.beta.-(3,5-di-tert-butyl-4-hydroxyphenyl)propionate; 1,1,3-tris(2-methyl-4-hydroxy-5-tert-butylphenyl)butane; 1,3,5-trimethyl-2,4,6-tris(3,5-di-tert-butyl-4-hydroxybenzyl)benzene; tetrakis[methylene-3-(3′,5′-di-tert-butyl-4′-hydroxyphenyl)propionate]met- hane, stearyl 3,5-di-tert-butyl-4-hydroxyhydrocinnamate; and so forth, as well as mixtures thereof.

In one particular embodiment, the hindered phenolic antioxidant comprises tetrakis[methylene-3-(3,5-di-tert-butyl-4-hydroxyphenyl-propionate)].

The hindered phenolic antioxidant can generally be present in the polymer composition in an amount from about 0.2% by weight to about 3.5% by weight, including all increments of 0.1% by weight therebetween. For example, the hindered phenolic antioxidant, for instance, can be present in the polymer composition in an amount greater than about 0.3% by weight, such as in an amount greater than about 0.5% by weight, such as in an amount greater than about 0.7% by weight, such as in an amount greater than about 0.9% by weight, such as in an amount greater than about 1.1% by weight, such as in an amount greater than about 1.3% by weight, such as in an amount greater than about 1.5% by weight, such as in an amount greater than about 1.7% by weight, such as in an amount greater than about 1.9% by weight, such as in an amount greater than about 2.1% by weight. In one embodiment, however, the phenolic antioxidant can be present in relatively minor amounts. For instance, the phenolic antioxidant can be present in an amount less than about 1.5% by weight, such as in an amount less than about 1% by weight, such as in an amount less than about 0.8% by weight.

As described above, the hindered phenolic antioxidant is combined with an aromatic amine stabilizer and a thioester stabilizer. The aromatic amine stabilizer can comprise any suitable nitrogen-containing antioxidant, such as a secondary aryl amine. The aromatic amine antioxidant, for instance, can be a reaction product of a diphenylamine with acetone. Particular examples of aromatic amine antioxidants include 4,4′-bis(1,1′-dimethylbenzyl)diphenylamine, 2,2,4-trimethyl-1,2-dihydroquinoline, p-(p-toluene-sulfonylamido)-diphenylamine and N,N′-diphenyl-p-phenylene-diamine, 4,4′-bis(a,a-tertiaryoctyl)diphenylamine, 4,4′-bis(a-methylbenzhydryl)diphenylamine, or mixtures thereof.

In one particular embodiment, the aromatic amine stabilizer can be 4-(1-methyl-1-phenylethyl)N-[4-[1-methyl-1-phenylethyl)phenyl]aniline.

The aromatic amine stabilizer can generally be present in the polymer composition in an amount from about 0.05% to about 1.5% by weight including all increments of 0.05% by weight therebetween. For instance, the aromatic amine stabilizer can be present in the composition in an amount greater than about 0.1% by weight, such as in an amount greater than about 0.2% by weight, such as in an amount greater than about 0.3% by weight. The aromatic amine stabilizer is generally present in the composition in an amount less than about 1.3% by weight, such as in an amount less than about 1% by weight, such as in an amount less than about 0.8% by weight, such as in an amount less than about 0.6% by weight, such as in an amount less than about 0.5% by weight.

The thioester stabilizer present in the composition can be a thiocarboxylic acid ester. The thioester stabilizer, for instance, can have the following general structure:

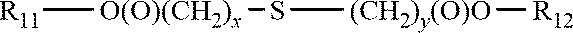

wherein,
x and y are independently from 1 to 10, in some embodiments 1 to 6, and in some embodiments, 2 to 4 (e.g., 2);
R₁₁ and R₁₂ are independently selected from linear or branched, C₆ to C₃₀ alkyl, in some embodiments C₁₀ to C₂₄ alkyl, and in some embodiments, C₁₂ to C₂₀ alkyl, such as lauryl, stearyl, octyl, hexyl, decyl, dodecyl, oleyl, etc.

Specific examples of suitable thiocarboxylic acid esters may include for instance, distearyl thiodipropionate, dilauryl thiodipropionate, di-2-ethylhexyl-thiodipropionate, diisodecyl thiodipropionate, etc.

In one embodiment, the thioester stabilizer can be a dicarboxylic acid ester. For instance, in one aspect, the thioester stabilizer can comprise distearyl thiodipropionate.

The thioester stabilizer can generally be present in the polymer composition in an amount from about 0.03% by weight to about 1.3% by weight including all increments of 0.01 % by weight therebetween. For example, the thioester stabilizer can be present in the polymer composition in an amount greater than about 0.05% by weight, such as in an amount greater than about 0.08% by weight, such as in an amount greater than about 0.1% by weight, such as in an amount greater than about 0.13% by weight, such as in an amount greater than about 0.15% by weight, such as in an amount greater than about 0.17% by weight. The thioester stabilizer is generally present in the polymer composition in an amount less than about 1.1% by weight, such as in an amount less than about 0.9% by weight, such as in an amount less than about 0.7% by weight, such as in an amount less than about 0.5% by weight, such as in an amount less than about 0.3% by weight.

In one embodiment, the hindered phenolic antioxidant is present in the polymer composition in amounts greater than the aromatic amine stabilizer and the thioester stabilizer. The aromatic amine stabilizer can also be present in the polymer composition in an amount greater than the thioester stabilizer. In one aspect, the weight ratio between the hindered phenolic antioxidant and the aromatic amine stabilizer can be from about 10:1 to about 1:1, such as from about 5:1 to about 1:1, such as from about 3:1 to about 1.5:1. The weight ratio of the hindered phenolic antioxidant to the thioester stabilizer, on the other hand, can be from about 15:1 to about 1:1, such as from about 8:1 to about 1.5:1, such as from about 5:1 to about 2:1.

The combination of stabilizers as described above is combined with a polyoxymethylene polymer in formulating the polymer composition of the present disclosure. Of particular advantage, it was discovered that the combination of stabilizers can be combined with polyoxymethylene polymers that have been taught in the past as not being suitable in formulating compositions for producing articles with acid resistance. For example, those skilled in the art have taught against the use of polyoxymethylene polymers having a relatively high hemiformal terminal group content. For example, U.S. Pat. No. 10,844,191 states that in order to produce a viable acid resistant polyoxymethylene polymer composition, “it is essential that the hemiformal terminal group content is 0.8 mmol/kg or less.”

To the contrary, the combination of stabilizers has been found to counteract and even possibly reverse any alleged decrease in acid resistance when formulating a polymer composition containing a polyoxymethylene polymer having a relatively high hemiformal terminal group content. For instance, although any suitable polyoxymethylene polymer may be incorporated into the composition, in one aspect, the polyoxymethylene polymer has a hemiformal terminal group content of greater than 0.81 mmol/kg, such as greater than about 0.85 mmol/kg, such as greater than about 0.9 mmol/kg, such as greater than about 0.95 mmol/kg, such as greater than about 1 mmol/kg, such as greater than about 1.2 mmol/kg. The hemiformal group content is generally less than about 3 mmol/kg, such as less than about 2 mmol/kg.

The content of terminal hemiformal group in the polyoxymethylene copolymer is determined as follows. Polyoxymethylene copolymer is dissolved in anhydrous hexafluoro-2-propanol (HFIP) at a reaction temperature between 40 and 50° C. at a concentration of 2.9 to 3.1% by weight. In a separate vial, pyridine is added to a silylating agent, N,O-bis(trimethylsilyl)trifluoroacetam ide (BSTFA), at a concentration of 7.0 to 8.0 % by weight; the solution is stirred at the reaction temperature. The amount of BSTFA used is in large excess relative to the polyoxymethylene copolymer and is approximately 1.5 to 2 times the volume of the copolymer solution. The polyoxymethylene copolymer solution is added dropwise to the stirring BSTFA mixture, which quickly becomes cloudy with precipitate. The reaction mixture is stirred for 30 min at the reaction temperature. The mixture is then removed from heat and dried using a nitrogen stream. The copolymer is redissolved in HFIP and dried again, with this cycle being repeated a total of three times. A portion of the obtained silylated copolymer is dissolved in deuterated HFIP (HFIP-d₂) and transferred to an NMR sample tube. The ¹H NMR spectra are collected at 37° C. using the residual solvent signal as an internal standard. The peaks of interest are are analyzed; one example of suitable parameters includes 256 scans per spectrum with a flip angle of 30° using a Bruker Avance III 400 MHz spectrometer. The newly formed tetramethyl silyl ether groups, corresponding to hemiformal and hydroxyethoxy end groups at 0.26 (C) and 0.23 ppm respectively, are observed. The quantification of the terminal hemiformal group (H) is performed relative to peaks corresponding to the oxymethylene unit (A) and the comonomer unit (B) of the polyoxymethylene copolymer at 4.98 ppm and 3.84 ppm:

$$H = \frac{\frac{C}{9}}{30.0 \frac{g}{m o l} \times \frac{A}{2} + 44.1 \frac{g}{m o l} \times \frac{B}{4}} \times {10}^{6} \frac{m m o l ⋅ g}{k g ⋅ m o l}$$

The calculation can be adjusted to include other components of the polymer structure as is appropriate.

The preparation of the polyoxymethylene polymer can be carried out by polymerization of polyoxymethylene-forming monomers, such as trioxane or a mixture of trioxane and a cyclic acetal such as dioxolane in the presence of a molecular weight regulator, such as a glycol. The polyoxymethylene polymer used in the polymer composition may comprise a homopolymer or a copolymer. According to one embodiment, the polyoxymethylene is a homo- or copolymer which comprises at least 50 mol.%, such as at least 75 mol.%, such as at least 90 mol.% and such as even at least 97 mol.% of —CH₂O—repeat units.

In one embodiment, a polyoxymethylene copolymer is used. The copolymer can contain from about 0.1 mol.% to about 20 mol.% and in particular from about 0.5 mol.% to about 10 mol.% of repeat units that comprise a saturated or ethylenically unsaturated alkylene group having at least 2 carbon atoms, or a cycloalkylene group, which has sulfur atoms or oxygen atoms in the chain and may include one or more substituents selected from the group consisting of alkyl cycloalkyl, aryl, aralkyl, heteroaryl, halogen or alkoxy. In one embodiment, a cyclic ether or acetal is used that can be introduced into the copolymer via a ring-opening reaction.

Preferred cyclic ethers or acetals are those of the formula:

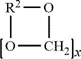

in which x is 0 or 1 and R² is a C₂ -C₄ -alkylene group which, if appropriate, has one or more substituents which are C₁-C₄-akyl groups, or are C₁-C₄-alkoxy groups, and/or are halogen atoms, preferably chlorine atoms. Merely by way of example, mention may be made of ethylene oxide, propylene 1,2-oxide, butylene 1,2-oxide, butylene 1,3-oxide, 1,3-dioxane, 1,3-dioxolane, and 1,3-dioxepan as cyclic ethers, and also of linear oligo- or polyformals, such as polydioxolane or polydioxepan, as comonomers.

In one embodiment, the polyoxymethylene polymer present in the polymer composition is a copolymer containing relatively low amounts of comonomer, such as dioxolane. For example, the polyoxymethylene copolymer can contain comonomer units in an amount less than about 2% by weight, such as in an amount less than about 1.8% by weight, such as in an amount less than about 1.7% by weight, such as in an amount less than about 1.6% by weight. The comonomer content of the polyoxymethylene copolymer can generally be greater than about 0.3% by weight, such as in an amount greater than about 0.5% by weight, such as in an amount greater than about 0.7% by weight, such as in an amount greater than about 0.9% by weight, such as in an amount greater than about 1.1% by weight, such as in an amount greater than about 1.3% by weight.

The polymerization can be effected as precipitation polymerization or in the melt. By a suitable choice of the polymerization parameters, such as duration of polymerization or amount of molecular weight regulator, the molecular weight and hence the MVR value of the resulting polymer can be adjusted.

In one embodiment, the polyoxymethylene polymer used in the polymer composition may contain a relatively high amount of reactive groups or functional groups in the terminal positions. The reactive groups, for instance, may comprise —OH or —NH₂ groups.

In one embodiment, the polyoxymethylene polymer can optionally have terminal hydroxyl groups, for example hydroxyethylene groups and/or hydroxyl side groups, in at least more than about 50% of all the terminal sites on the polymer. For instance, the polyoxymethylene polymer may have at least about 70%, such as at least about 80%, such as at least about 85% of its terminal groups be hydroxyl groups, based on the total number of terminal groups present. It should be understood that the total number of terminal groups present includes all side terminal groups. The quantification of the hydroxyl group content in the polyoxymethylene polymer may be conducted by the method described in JP-A-2001-11143, which is incorporated herein by reference.

In one embodiment, the polyoxymethylene polymer optionally has a content of terminal hydroxyl groups of at least 15 mmol/kg, such as at least 18 mmol/kg, such as at least 20 mmol/kg. In one embodiment, the terminal hydroxyl group content ranges from 18 to 80 mmol/kg. In an alternative embodiment, the polyoxymethylene polymer may contain terminal hydroxyl groups in an amount less than 100 mmol/kg, such as less than 50 mmol/kg, such as less than 20 mmol/kg, such as less than 18 mmol/kg, such as less than 15 mmol/kg. For instance, the polyoxymethylene polymer may contain terminal hydroxyl groups in an amount from about 5 mmol/kg to about 20 mmol/kg, such as from about 5 mmol/kg to about 15 mmol/kg. For example, a polyoxymethylene polymer may be used that has a lower terminal hydroxyl group content but has a higher melt volume flow rate.

In addition to or instead of the terminal hydroxyl groups, the polyoxymethylene polymer may also have other terminal groups usual for these polymers. Examples of these are alkoxy groups, hemiformal groups as discussed above, acetate groups or aldehyde groups. According to one embodiment, the polyoxymethylene is a homo- or copolymer which comprises at least 50 mol-%, such as at least 75 mol-%, such as at least 90 mol-% and such as even at least 95 mol-% of —CH₂O—repeat units.

In one embodiment, a polyoxymethylene polymer can be produced using a cationic polymerization process followed by solution hydrolysis to remove a proportion of unstable end groups. During cationic polymerization, a glycol, such as ethylene glycol or methylal can be used as a chain terminating agent. A heteropoly acid, triflic acid or a boron compound may be used as the catalyst.

The polyoxymethylene polymer can have any suitable molecular weight. The molecular weight of the polymer, for instance, can be from about 4,000 grams per mole to about 20,000 g/mol. In other embodiments, however, the molecular weight can be well above 20,000 g/mol, such as from about 20,000 g/mol to about 200,000 g/mol.

The polyoxymethylene polymer present in the composition can generally have a melt flow index (MFI) ranging from about 1 to about 50 g/10 min, such as from about 9 g/10 min to about 27 g/10 min as determined according to ISO Test 1133 at 190° C. and 2.16 kg, though polyoxymethylenes having a higher or lower melt flow index are also encompassed herein. In one embodiment, the polyoxymethylene polymer has a melt flow index of generally greater than about 10 g/10 min. For example, the polyoxymethylene polymer can have a melt flow index of greater than about 11 g/10 min, greater than about 12 g/10 min. The melt flow index of the polyoxymethylene polymer can be less than about 35 g/10 min, such as less than about 30 g/10 min, such as less than about 25 g/10 min, such as less than about 20 g/10 min, such as less than about 14 g/10 min. In one embodiment, the polyoxymethylene polymer can have a relatively low melt flow index of less than about 5 g/10 min, such as less than about 4 g/10 min, such as less than about 3 g/10 min, and generally greater than about 0.1 g/10 min.

The polyoxymethylene polymer may be present in the polyoxymethylene polymer composition in an amount of at least 50 wt.%, such as at least 60 wt.%, such as at least 75 wt.%, such as at least 80 wt.%, such as at least 85 wt.%, such as at least 90 wt.%, such as at least 93 wt.%. In general, the polyoxymethylene polymer is present in an amount of less than about 100 wt.%, such as less than about 97 wt.%, such as less than about 95 wt.%, wherein the weight is based on the total weight of the polyoxymethylene polymer composition.

According to the present disclosure, the polyoxymethylene polymer is combined with at least one acid neutralizing agent and optionally a plasticizer. The acid neutralizing agent generally comprises a metal compound and/or a hydroxide, an oxide, a sulfide or a carbonate.

In one aspect, at least one of the acid neutralizing agents is a magnesium compound. For instance, the polymer composition of the present disclosure can contain a single magnesium compound or a plurality of magnesium compounds. Magnesium compounds particularly well suited for use in the present disclosure include magnesium hydroxide alone, magnesium oxide, alone or a combination magnesium hydroxide and magnesium oxide. In accordance with the present disclosure, one or more magnesium compounds are added to the polymer composition so as to achieve a particular magnesium content found to be particularly well suited for providing acid resistance. The magnesium content of the polymer composition, for instance, can be greater than about 1.8% by weight, such as greater than about 2% by weight, such as greater than about 2.2% by weight, such as greater than about 2.4% by weight, such as greater than about 2.6% by weight, such as greater than about 2.8% by weight, such as greater than about 3% by weight, such as greater than about 3.2% by weight, such as greater than about 3.4% by weight, such as greater than about 3.6% by weight. The magnesium content of the polymer composition is generally less than about 8.5% by weight, such as less than about 7% by weight, such as less than about 6% by weight, such as less than about 5% by weight. In one embodiment, the magnesium content of the polymer composition is less than about 4.1 % by weight.

In one embodiment, the polymer composition contains only magnesium oxide. The magnesium oxide can be present in the polymer composition in an amount sufficient for the polymer composition to have a magnesium content of from about 2.5% by weight to about 6.5% by weight.

In an alternative embodiment, the polymer composition can contain magnesium hydroxide alone or in combination with magnesium oxide. The magnesium hydroxide can be present in the polymer composition such that the magnesium hydroxide contributes from about 0.6% to about 4.5% by weight of magnesium to the polymer composition. For instance, magnesium hydroxide can be added to the polymer composition so as to provide a magnesium content of greater than about 0.8% by weight, such as greater than about 1.2% by weight, such as greater than about 1.5% by weight, such as greater than about 1.8% by weight, such as greater than about 2% by weight, such as greater than about 2.2% by weight, such as greater than about 2.5% by weight, such as greater than about 2.8% by weight, such as greater than about 3% by weight, such as greater than about 3.2% by weight, such as greater than about 3.5% by weight, and generally less than about 6.3% by weight, such as less than about 5.5% by weight, such as less than about 4.1% by weight. As described above, magnesium hydroxide can be present alone or in combination with magnesium oxide. When magnesium oxide is present in combination with magnesium hydroxide, the magnesium oxide can also be present so as to provide a magnesium content to the polymer composition in the same amounts as described above with respect to magnesium hydroxide.

In addition to one or more magnesium compounds, various other acid neutralizing agents can also be added to the polymer composition. For instance, other acid neutralizing agents that may be used include zinc oxide, zinc sulfide, sulfur sulfide, calcium carbonate, or mixtures thereof.

In one embodiment, the acid neutralizing agent can have a relatively small particle size combined with a high surface area. Each acid neutralizing agent, for example, can have a BET surface area of greater than about 25 m²/g, such as greater than about 35 m²/g, such as greater than about 45 m²/g, such as greater than about 55 m²/g, such as greater than about 65 m²/g, such as greater than about 75 m²/g, such as greater than about 85 m²/g, such as greater than about 95 m²/g, such as greater than about 105 m²/g, such as greater than about 115 m²/g, such as greater than about 125 m²/g, such as greater than about 135 m²/g, such as greater than about 145 m²/g, such as greater than about 155 m²/g, such as greater than about 165 m²/g, such as greater than about 175 m²/g, such as greater than about 185 m²/g, such as greater than about 195 m²/g, such as greater than about 205 m²/g, such as greater than about 215 m²/g. The BET surface area is generally less than about 400 m²/g.

In one aspect, one or more acid neutralizing agents are present in the polymer composition in an amount greater than 2% by weight, such as in an amount greater than 2.5% by weight, such as in an amount greater than about 3% by weight, such as in an amount greater than about 3.5% by weight, such as in an amount greater than about 4% by weight, such as in an amount greater than about 4.5% by weight, such as in an amount greater than about 5% by weight, such as in an amount greater than about 5.2% by weight, such as in an amount greater than about 5.5% by weight, such as in an amount greater than about 5.7% by weight, such as in an amount greater than about 6% by weight, such as in an amount greater than about 6.5% by weight, such as in an amount greater than about 7% by weight, such as in an amount greater than about 8% by weight, such as in an amount greater than about 9% by weight, such as in an amount greater than about 10% by weight, such as in an amount greater than about 11% by weight, such as in an amount greater than about 12% by weight. One or more acid neutralizing agents are present in the composition generally in an amount less than about 25% by weight, such as in an amount less than about 22% by weight, such as in an amount less than about 20% by weight, such as in an amount less than about 18% by weight, such as in an amount less than about 15% by weight, such as in an amount less than about 12% by weight, such as in an amount less than about 10% by weight, such as in an amount less than about 8% by weight.

In addition to the polyoxymethylene polymer and an acid neutralizing agent, the polymer composition can further contain a plasticizer. The plasticizer can comprise a polyalkylene glycol, an ester, a polyester, an epoxide, a sulfonamide, a polyether, a polyamide, a polybutene, an acetylated monoglyceride, an alkyl citrate, an organophosphate, or mixtures thereof.

For instance, in one embodiment, the plasticizer comprises polyethylene glycol. The mean molecular weight of the plasticizer can generally be greater than about 1,000 g/mol, such as greater than about 3,000 g/mol, such as greater than about 5,000 g/mol. The mean molecular weight of the plasticizer is generally less than about 55,000 g/mol, such as less than about 30,000 g/mol, such as less than about 15,000 g/mol, such as less than about 8,000 g/mol.

In an alternative embodiment, the plasticizer may have ester functionality and may comprise a phthalate, an adipate, a sebacate, a maleate, a trimellitate, a benzoate, or mixtures thereof. Examples of suitable phthalates are diisobutyl phthalate (DIBP), dibutyl phthalate (DBP), diisoheptyl phthalate (DIHP), L 79 phthalate, L711 phthalate, dioctyl phthalate, diisooctyl phthalate, dinonyl phthalate, diisononyl phthalate, diisodecyl phthalate, L911 phthalate, diundecyl phthalate, diisoundecyl phthalate, undecyl dodecyl phthalate, diisotridecyl phthalate (DTDP) and butyl benzyl phthalate (BBP).

Examples of adipates are dioctyl adipate, diisononyl adipate and diisodecyl adipate. An example for a trimellitate is trioctyl trimellitate. Phosphate esters can also be used. Suitable examples are tri-2-ethylhexyl phosphate, 2-Ethylhexyl diphenyl phosphate and tricresyl phosphate.

Sebacates and azelates include di-2-ethylhexyl sebacate (DOS) and di-2-ethylhexyl azelate (DOZ).

Polyester plasticizers are typically based on condensation products of propane- or butanediols with adipic acid or phthalic anhydride. The growing polymer chain of these polyesters may then be end-capped with an alcohol or a monobasic acid, although non-end-capped polyesters can be produced by strict control of the reaction stoichiometry.

Further plasticizers are benzoates which are commercially available as JAYFLEX® MB10, BENZOFLEX®2088, BENZOFLEX® LA-705, and BENXOFLEX® 9-88. Epoxide based plasticizer include epoxidized vegetable oils.

In one embodiment, the plasticizer is an aromatic benzene sulfonamides. Preference is given to benzene sulfonamides represented by the general formula (I):

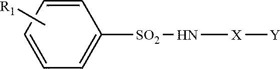

in which R1 represents a hydrogen atom, a C₁-C₄ alkyl group or a C₁-C₄ alkoxy group, X represents a linear or branched C₂-C₁₀ alkylene group, or an alkyl group, or a methylene group, or a cycloaliphatic group, or an aromatic group, and Y represents one of the groups H, OH or

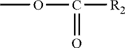

in which R₂ represents a C₁-C₄ alkyl group or an aromatic group, these groups optionally themselves being substituted by an OH or C₁-C₄ alkyl group.

The preferred aromatic benzenesulphonamides of formula (I) are those in which:

R₁ represents a hydrogen atom or a methyl or methoxy group, X represents a linear or branched C₂-C₁₀ alkylene group or a phenyl group, Y represents an H, OH or —O—CO—R₂ group, R₂ representing a methyl or phenyl group, the latter being themselves optionally substituted by an OH or methyl group.

Mention may be made, among the aromatic sulphonamides of formula (I) which are liquid (L) or solid (S) at room temperature as specified below, of the following products, with the abbreviations which have been assigned to them:
N-(2-hydroxyethyl)benzenesulphonamide (L),
N-(3-hydroxypropyl)benzenesulphonamide (L),
N-(2-hydroxyethyl)-p-toluenesulphonamide (S),
N-(4-hydroxyphenyl)benzenesulphonamide (S),
N-[(2-hydroxy-1 -hydroxymethyl-1 -methyl)ethyl]benzenesulphonamide (L),
N-[5-hydroxy-1,5-dimethylhexyl]benzenesulphonamide (S),
N-(2-acetoxyethyl)benzenesulphonamide (S),
N-(5-hydroxypentyl)benzenesulphonamide (L),
N-[2-(4-hydroxybenzoyloxy)ethyl]benzene-sulphonamide (S),
N-[2-(4-methylbenzoyloxy)ethyl]benzenesulphonamide (S),
N-(2-hydroxyethyl)-p-methoxybenzenesulphonamide (S) and
N-(2-hydroxypropyl)benzenesulphonamide (L).

One particular plasticizer is a sulfonamide, for example N-(n-butyl)benzene sulfonamide.

The amount of plasticizer present in the polymer composition can depend upon the amount of acid neutralizing agent present as well as various other factors. In general, the plasticizer is present in the composition in an amount greater than about 0.8% by weight, such as in an amount greater than about 1.2% by weight, such as in an amount greater than about 1.6% by weight, such as in an amount greater than about 1.8% by weight. The plasticizer is generally present in an amount less than about 12% by weight, such as in an amount less than about 8% by weight, such as in an amount less than about 6% by weight, such as in an amount less than about 3% by weight.

In addition to the polyoxymethylene polymer, the combination of stabilizers, at least one acid neutralizing agent, and the plasticizer, various other components and ingredients can be contained in the composition for improving one or more properties. For example, in one embodiment, the composition may contain a conductive filler so that any article molded from the composition exhibits electrostatic dissipative (ESD) capabilities. The conductive filler can include conductive particles, powders, fibers or combinations thereof. For instance, the conductive filler may comprise metal powders, metal flakes, metal fibers (i.e., stainless steel fibers), carbon powder, carbon fibers, carbon black, carbon nanotubes, or combinations thereof.

Further, the conductive filler can be present in the polymer composition of the present disclosure in an amount ranging from about 1% by weight to about 30% by weight, such as in an amount ranging from about 1.5% by weight to about 25% by weight, such as in an amount ranging from about 2% by weight to about 20% by weight, based on the total weight of the polymer composition.

In one embodiment, a copolyamide can be present in the polymer composition for reducing formaldehyde emissions. The copolyamide can have a softening point of generally greater than about 120° C., such as greater than about 130° C., such as greater than about 140° C., such as greater than about 150° C., such as greater than about 160° C., such as greater than about 170° C. The softening point of the copolyamide may be less than about 210° C., such as less than about 200° C., such as less than about 190° C., such as less than about 185° C. The copolyamide may have a melt viscosity at 230° C. of greater than about 7 Pa s, such as greater than about 8 Pa s, such as greater than about 9 Pa s. The melt viscosity is generally less than about 15 Pa s, such as less than about 14 Pa s, such as less than about 13 Pa s. In one embodiment, the copolyamide is ethanol soluble. In one embodiment, the copolyamide may comprise a polycondensation product of polymeric fatty acids with aliphatic diamines. The copolyamide can generally be present in the composition in an amount greater than about 0.01 % by weight, such as in an amount greater than about 0.03% by weight, such as in an amount greater than about 0.05% by weight. The copolyamide is generally present in an amount less than about 2% by weight, such as in an amount less than about 1.5% by weight, such as in an amount less than about 1% by weight, such as in an amount less than about 0.5% by weight, such as in an amount less than about 0.1% by weight.

In one embodiment, an acid scavenger may be present. The acid scavenger may comprise, for instance, an alkaline earth metal salt. For instance, the acid scavenger may comprise a calcium salt, such as a calcium citrate or a calcium carbonate. In one embodiment, the acid scavenger may comprise tricalcium citrate. The acid scavenger may be present in an amount of at least about 0.01 wt.%, such as at least about 0.05 wt.%, such as at least about 0.09 wt.%. In one embodiment, greater amounts of an acid scavenger are used, such as when the acid scavenger is a carbonate. For example, the acid scavenger can be present in an amount greater than about 2 wt.%, such as greater than about 5 wt.%, such as greater than about 7 wt. %. The acid scavenger is generally present in an amount less than about 10 wt.%, such as less than about 7 wt. %, such as less than about 5 wt.%, such as less than about 1 wt.%, such as less than about 0.75 wt.%, such as less than about 0.5 wt.%, wherein the weight is based on the total weight of the respective polymer composition.

In one embodiment, a nucleant may be present. The nucleant may increase crystallinity and may comprise an oxymethylene terpolymer. In one particular embodiment, for instance, the nucleant may comprise a terpolymer of butanediol diglycidyl ether, ethylene oxide, and trioxane. In one embodiment, the terpolymer nucleant can have a relatively small particle size, such as having a d50 particle size of less than about 1 micron, such as less than about 0.8 microns, such as less than about 0.6 microns, such as less than about 0.4 microns, and generally greater than 0.01 microns. Other nucleants that may be used include a polyamide, boron nitride, or a talc. The polyamide nucleant may be PA6 or PA12. The nucleant may be present in the composition in an amount of at least about 0.01 wt.%, such as at least about 0.05 wt.%, such as at least about 0.1 wt.% and less than about 2 wt.%, such as less than about 1.5 wt.%, such as less than about 1 wt.%, wherein the weight is based on the total weight of the respective polymer composition.

In one embodiment, lubricants may be present. The lubricant may comprise a polymer wax composition. In one embodiment, a fatty acid amide such as ethylene bis(stearamide) may be present. In an alternative embodiment, the lubricant may comprise a polyalkylene glycol that has a relatively low molecular weight in relation to the plasticizer. For instance, the lubricant may comprise a polyethylene glycol that has a mean molecular weight of from about 500 to about 4,000. Lubricants may generally be present in the polymer composition in an amount of at least about 0.01 wt.%, such as at least about 0.05 wt.%, such as at least about 0.1 wt.% and less than about 1 wt.%, such as less than about 0.75 wt.%, such as less than about 0.5 wt.%, wherein the weight is based on the total weight of the respective polymer composition.

In one embodiment, a coloring agent may be present. Coloring agents that may be used include any desired inorganic pigments, such as titanium dioxide, ultramarine blue, cobalt blue, and other organic pigments and dyes, such as phthalocyanines, anthraquinnones, and the like. Other coloring agents include carbon black or various other polymer-soluble dyes. In one embodiment, a combination of coloring agents may be included in the polymer composition. For instance, the polymer composition may contain carbon black. In an alternative embodiment, the coloring agents present in the polymer composition may comprise titanium dioxide in combination with at least one color pigment, such as a yellow pigment and a green pigment and optionally further in combination with carbon black. The coloring agent may be present in the composition in an amount of at least about 0.01 wt.%, such as at least about 0.05 wt.%, such as at least about 0.1 wt.%, such as at least about 0.5 wt.%, and less than about 5 wt.%, such as less than about 2.5 wt.%, such as less than about 1 wt.%, wherein the weight is based on the total weight of the respective polymer composition.

One or more light stabilizers may also be contained within the composition. In one embodiment, lights stabilizers, such as sterically hindered amines, may be present in addition to the ultraviolet light stabilizer. Hindered amine light stabilizers that may be used include oligomeric hindered amine compounds that are N-methylated. For instance, hindered amine light stabilizer may comprise a high molecular weight hindered amine stabilizer. The light stabilizers, when present, may be present in the polymer composition in an amount of at least about 0.01 wt.%, such as at least about 0.05 wt.%, such as at least about 0.075 wt.% and less than about 1 wt.%, such as less than about 0.75 wt.%, such as less than about 0.5 wt.%, wherein the weight is based on the total weight of the respective polymer composition.

In one embodiment, an ultraviolet light stabilizer may be present. The ultraviolet light stabilizer may comprise a benzophenone, a benzotriazole, or a benzoate. The UV light absorber, when present, may be present in the polymer composition in an amount of at least about 0.01 wt.%, such as at least about 0.05 wt.%, such as at least about 0.075 wt.% and less than about 1 wt.%, such as less than about 0.75 wt.%, such as less than about 0.5 wt.%, wherein the weight is based on the total weight of the respective polymer composition.

In one embodiment, however, the polymer composition is free of any light stabilizers. For instance, the composition may be free of an ultraviolet light stabilizer or a hindered amine light stabilizer.

In one aspect, a nitrogen-containing formaldehyde scavenger may optionally be present in the polymer composition. In an alternative embodiment, however, the polymer composition can be formulated so as to be completely free of any nitrogen-containing formaldehyde scavengers. Mainly, of these are heterocyclic compounds having at least one nitrogen atom as hetero atom which is either adjacent to an amino-substituted carbon atom or to a carbonyl group, for example pyridine, pyrimidine, pyrazine, pyrrolidone, aminopyridine and compounds derived therefrom. Such compounds are triamino-1,3,5-triazine (melamine) and its derivatives, such as melamine-formaldehyde condensates and methylol melamine. Other compounds include guanamine compounds.

The polymer composition may also optionally contain one or more reinforcing agents. For instance, the polymer composition may contain reinforcing fibers, such as glass fibers, carbon fibers, and the like. The reinforcing fibers can generally be present in an amount from about 2% to about 40% by weight, such as from about 10% to about 25% by weight.

The compositions of the present disclosure can be compounded and formed into a polymer article using any technique known in the art. For instance, the respective composition can be intensively mixed to form a substantially homogeneous blend. The blend can be melt kneaded at an elevated temperature, such as a temperature that is higher than the melting point of the polymer utilized in the polymer composition but lower than the degradation temperature. Alternatively, the respective composition can be melted and mixed together in a conventional single or twin screw extruder. Preferably, the melt mixing is carried out at a temperature ranging from 100 to 280° C., such as from 120 to 260° C., such as from 140 to 240° C. or 180 to 220° C.

After extrusion, the compositions may be formed into pellets. The pellets can be molded into polymer articles by techniques known in the art such as injection molding, thermoforming, blow molding, rotational molding and the like.

In one embodiment, the polymer composition can be used to produce polymer articles designed for the automotive field. The polymer articles, for instance, may be designed to be an exterior vehicle part. In one embodiment, the molded articles are formed into a fuel contacting member. The fuel contacting member, for instance, may be one or more parts contained in the fuel system of a vehicle, such as a car or truck. The fuel contacting member, for instance, may be designed for repeated contact with diesel fuel.

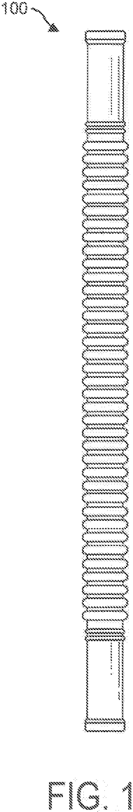

Referring to FIG. 1, for instance, a fuel line 100 is shown formed from the polymer composition of the present disclosure. The fuel line 100, for instance, comprises, in this embodiment, a corrugated tube.

In addition to fuel lines, the polymer composition of the present disclosure can be used to produce fuel tanks, components of a fuel pump, components of a fuel filter, a fuel rail, components of an injector, a pressure regulator, and a return fuel line.

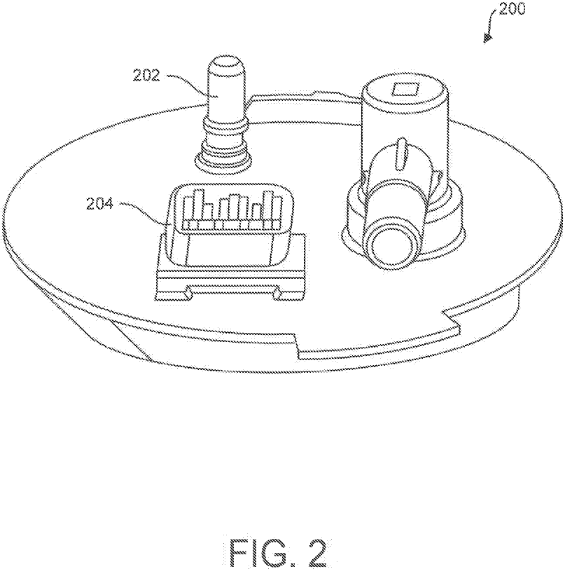

In one embodiment, the polymer composition is used to produce a fuel flange 200 as shown in FIG. 2. The fuel flange 200, for instance, is designed to be placed on a fuel tank and connected to one or more fuel lines. For example, as shown in FIG. 2, the fuel flange 200 can include at least one fuel inlet or outlet 202 for feeding fuel to a fuel tank and for dispensing fuel from the fuel tank. The fuel flange 200 can also include an electrical connector 204 for connecting a controller contained within the vehicle to various sensors that may be present in and around the fuel tank.

The polymer composition can possess a combination of physical properties and acid resistance that makes the polymer composition well suited for many applications in addition to being used in fuel related applications. For example, when tested according to GM test GMW18052, the polymer composition displays an acid resistance of greater than 30 cycles to maintain 75% tensile stress and greater than 10 cycles to maintain 35% tensile stress, displays a tensile modulus of greater than 2500 MPa, displays a tensile strength at yield of greater than 54 MPa, displays a Charpy notched impact strength at 23 C of greater than 4 kJ/m², displays a Charpy notched impact strength at -30 C of greater than 3 kJ/m², displays a density of from 1.4 g/cm³ to 1.46 g/cm³, displays a melting temperature of from 168 C to 175 C, displays a DTUL of greater than 90 C, and displays a melt flow rate of from 9 g/10 min to 16 g/16 min. For example, the polymer composition can display a tensile modulus of greater than 2800 MPa, such as greater than 3000 MPa and generally less than 4500 MPa, displays a tensile strength at yield of greater than 56 MPa, such as greater than 58 MPa and generally less than 70 MPa, displays a Charpy notched impact strength at 23 C of greater than about 5 kJ/m², such as greater than about 5.5 kJ/m² and generally less than about 9 kJ/m², displays a Charpy notched impact strength at -30 C of greater than about 5 kJ/m², such as greater than about 5.4 kJ/m², and generally less than about 8.5 kJ/m².

The present disclosure may be better understood with reference to the following example.

### EXAMPLE

The following example is provided to further illustrate the invention but not to limit its scope. Other variants of the invention will be readily apparent to one of ordinary skill in the art and are encompassed by the appended claims.

### Example 1

In this example, various polymer compositions were formulated and tested for resistance against a highly acidic solution. The polymer compositions were also test for various physical properties.

The following polymer compositions were formulated:

| Components | Sample 1 wt. % | Sample 2 wt. % | Sample 3 wt. % |
|---|---|---|---|
| Polyoxymethylene copolymer (MFI=13 g/10 min, 0.29 mmol/kg hemiformal) | 90.6 | | |
| Polyoxymethylene copolymer (MFI=13 g/10 min, 0.88 mmol/kg hemiformal) | | 90.6 | |
| Polyoxymethylene copolymer (MFI=12 g/10 min) | | | 100 |
| Phenolic antioxidant | 0.7 | 0.7 | - |
| Aromatic Amine antioxidant CAS # 10081671 | 0.3 | 0.3 | - |
| Distearyl thiodipropionate CAS # 693367 | 0.2 | 0.2 | - |
| Ethylene bis(stearamide) | 0.2 | 0.2 | - |
| Polyethylene glycol (MW=6,000) | 2 | 2 | - |
| Magnesium oxide particles | 6 | 6 | - |

The above compositions were injection molded into a tensile bar and tested for their media resistance against acidic car wash solution. Eagle One® Etching Mag Wheel Cleaner (pH 2~3) from Energizer Holdings was used as the test media. The test specimens were tested in 3 replicates each as below:

1. Each specimen was restrained at 2% bending strain. The fixture used was a 2-point bending apparatus and the % strain was controlled by the distance between two end-plates.

2. At the beginning of a day, the bars were sprayed with the media and covered with gauze to let soak.

3. The specimen was placed in an oven at 60 ±3° C. for 4 hours.

4. Upon removal from the oven, the specimen was sprayed with media, and let soaked under gauze at room temperature for 4 hours.

5. After 4 hours, the specimen was sprayed with media again and let soaked under gauze at room temperature overnight.

6. Processes 1~4 was considered as 1 cycle, and the cycles were repeated until the specimen broke through completely.

7. Prior to each spray, the specimen was visually inspected for any cracks or appearance changes using magnifying glass and light.

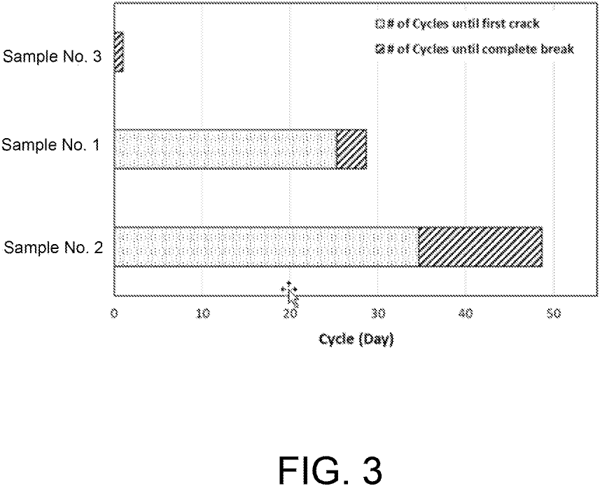

The following results were obtained (also shown in FIG. 3):

| | Hemiacetal endgroup content in polymer (mmol/kg) | Media resistance test | |
|---|---|---|---|
| | | Number of cycles until first crack appears | Number of cycles until the specimen break through completely |
| Sample No. 1 | 0.29 | 25 | 29 |
| Sample No. 2 | 0.88 | 35 | 49 |
| Sample No. 3 | nt | 0 | 1 |

Samples Nos. 1 and 2 displayed dramatic media resistance in comparison to Sample No. 3 only containing a polyoxymethylene polymer. Although Sample Nos. 1 and 2 both displayed excellent results, Sample No. 2 containing a polyoxymethylene polymer having a higher hemiformal end group content actually displayed more resistance to acid. This result is completely unexpected.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A polymer composition with acid resistant properties comprising:
a polyoxymethylene polymer;
an acid neutralizing agent; and
a combination of stabilizers, the combination of stabilizers including:
(a) a hindered phenolic antioxidant;
(b) an aromatic amine stabilizer; and
(c) a thioester stabilizer.

2. A polymer composition as defined in claim 1, wherein the polyoxymethylene polymer comprises a polyoxymethylene copolymer containing hemiformal end groups in an amount greater than about 0.8 mmol/kg and less than about 4 mmol/kg.

3. A polymer composition as defined in claim 1, wherein the hindered phenolic antioxidant is present in the composition in an amount greater than the amount of the aromatic amine stabilizer present and in an amount greater than the amount of thioester stabilizer present in the composition.

4. A polymer composition as defined in claim 1, wherein the hindered phenolic antioxidant is present in relation to the aromatic amine stabilizer at a weight ratio of from about 10:1 to about 1:1 and wherein the hindered phenolic antioxidant is present in the composition in relation to the thioester stabilizer at a weight ratio of from about 15:1 to about 1:1.

5. A polymer composition as defined in claim 1, wherein the hindered phenolic antioxidant is present in the composition in an amount from about 0.2% to about 3.5% by weight.

6. A polymer composition as defined in claim 1, wherein the hindered phenolic antioxidant is present in the composition in an amount less than about 1.5% by weight and in an amount greater than about 0.2% by weight.

7. A polymer composition as defined in claim 1, wherein the hindered phenolic antioxidant comprises tetrakis[methylene-3-(3,5-di-tert-butyl-4-hydroxyphenyl-propionate)].

8. A polymer composition as defined in claim 1, wherein the aromatic amine stabilizer comprises 4-(1-methyl-1-phenylethyl)N-[4-(1-methyl-1-phenylethyl)phenyl]aniline.

9. A polymer composition as defined in claim 8, wherein the aromatic amine stabilizer is present in the polymer composition in an amount from about 0.05% by weight to about 1.5% by weight.

10. A polymer composition as defined in claim 1, wherein the thioester stabilizer comprises distearyl thiodipropionate.

11. A polymer composition as defined in claim 1, wherein the thioester stabilizer is present in the polymer composition in an amount from about 0.03% by weight to about 1.3% by weight.

12. A polymer composition as defined in claim 1, wherein the acid neutralizing agent is present in the polymer composition in an amount greater than about 2.5% by weight and in an amount less than about 15% by weight.

13. A polymer composition as defined in claim 1, wherein the acid neutralizing agent comprises magnesium oxide.

14. A polymer composition as defined in claim 13, wherein the only acid neutralizing agent present in the composition is the magnesium oxide.

15. A polymer composition as defined in claim 1, wherein the acid neutralizing agent comprises magnesium hydroxide alone or in combination with a metal oxide, such as magnesium oxide or zinc oxide.

16. A polymer composition as defined in claim 1, further containing a plasticizer.

17. A polymer composition as defined in claim 16, wherein the plasticizer comprises a polyalkylene glycol.

18. A polymer composition as defined in claim 1, wherein the polymer composition further contains a lubricant.

19. A polymer composition as defined in claim 1, wherein the polyoxymethylene polymer has a melt flow index of greater than about 5 g/10 min and less than about 50 g/10 min when tested according to ISO Test 1133 at 190° C. and at a load of 2.16 kg, the polyoxymethylene polymer being present in the polymer composition in an amount from about 40% by weight to about 95% by weight.

20. A polymer composition as defined in claim 1, wherein the polymer composition displays an acid resistance of greater than 30 cycles to maintain 75% tensile stress and greater than 10 cycles to maintain 35% tensile stress, displays a tensile modulus of greater than 2500 MPa, displays a tensile strength at yield of greater than 54 MPa, displays a Charpy notched impact strength at 23 C of greater than 4 kJ/m², displays a Charpy notched impact strength at -30 C of greater than 3 kJ/m², displays a density of from 1.4 g/cm³ to 1.46 g/cm³, displays a melting temperature of from 168 C to 175 C, displays a DTUL of greater than 90 C, and displays a melt flow rate of from 9 g/10 min to 16 g/16 min.

21. A molded article made from the polymer composition as defined in claim 1, the molded article comprising an exterior vehicle part.

22. A molded article as defined in claim 21, wherein the exterior vehicle part comprises a fuel contacting member.

23. A molded article as defined in claim 21, wherein the molded article comprises a fuel line or fuel flange.
